(19) United States
(12) Patent Application Publication
(10) Pub. No.: US 2009/0081568 A1
(43) Pub. Date: Mar. 26, 2009

(54) EXPOSURE APPARATUS AND METHOD OF MANUFACTURING DEVICE

(75) Inventor: Go Tsuchiya, Utsunomiya-shi (JP)

Correspondence Address: MORGAN & FINNEGAN, L.L.P., 3 WORLD FINANCIAL CENTER, NEW YORK, NY, 10281-2101, US

(73) Assignee: CANON KABUSHIKI KAISHA, Tokyo (JP)

(21) Appl. No.: 12/212,156

(22) Filed: Sep. 17, 2008

(30) Foreign Application Priority Data
Sep. 20, 2007 (JP) 2007-244442

(51) Int. Cl. G03C 5/00; G03B 27/52

(52) U.S. Cl. 430/30; 355/55

(57) ABSTRACT

An exposure apparatus comprises a light source, a measuring instrument, a processor, and a controller, wherein the processor is configured to obtain a synthetic spectrum by synthesizing a spectrum of a first pulsed light and a spectrum of a second pulsed light, to obtain a central wavelength and light intensity of each of a plurality of spectrum elements included in the synthetic spectrum, and to calculate a central wavelength of the accumulated light based on the obtained central wavelength and light intensity of each of the plurality of spectrum elements, and the controller is configured to determine, based on the calculated central wavelength of the accumulated light, whether the substrate should be exposed to light.

### BACKGROUND OF THE INVENTION

1. Field of the Invention

The present invention relates to an exposure apparatus and a method of manufacturing a device.

2. Description of the Related Art

A lithography method is well known as a method of forming a predetermined circuit pattern on a semiconductor. The lithography method includes the step of forming a latent image pattern on a substrate coated with a photoresist by applying light to the substrate via a reticle and exposing the photoresist to the light, and then developing the photoresist. A mask pattern is formed by development, and etching or the like is performed by using the pattern.

Recently, with an increase in the integration of LSIs (Large Scale Integrated circuits) and the like, a further reduction in the size of circuit patterns has been required. In order to improve the processing accuracy in the lithography method, it is necessary to improve the resolution of an exposure apparatus.

As indicated by equation (1), it is known that a resolution R of the exposure apparatus is proportional to a wavelength λ of a light source, and is inversely proportional to the NA (Numerical Aperture) of a projection lens. Note that k1 is a proportionality constant.

R=k1·(λ/NA) (1)

The resolution of the exposure apparatus can therefore be improved by shortening the wavelength of a light source or increasing the numerical aperture of a projection lens.

A DOF (Depth Of Focus) is one of the characteristics of the optical system of an exposure apparatus. This depth of focus represents, by the distance from a focus point, the range in which the blur of a projected image is permitted. Such a depth of focus can be represented by

DOF=k2·(π/NA) (2)

where k2 is a proportionality constant.

If, therefore, the wavelength of the light source is shortened or the numerical aperture of the projection lens is increased to improve the resolution of the exposure apparatus, the depth of focus considerably decreases. This will shorten the distance in the optical axis direction which allows accurate processing.

For a next-generation device designed to increase the integration by decreasing the size of a circuit pattern and forming it into a three-dimensional structure, such a decrease in depth of focus raises a serious problem. This is because, since the processing dimension in the optical axis direction increases to implement a three-dimensional circuit pattern, sharp focusing is required in a wide range, and a constant depth of focus is always required regardless of the degree of miniaturization of a circuit.

In order to solve the above problem, attempts have been made to increase the depth of focus by forming reticle pattern images at different positions on the same optical axis by projecting a reticle pattern onto a substrate by using exposure light having different wavelengths.

Japanese Patent No. 02619473 has proposed a means which comprises light sources which oscillate at first and second wavelengths, respectively, and uses the light obtained by synthesizing the respective oscillation light beams as exposure light.

Japanese Patent Laid-Open No. 11-162824 has proposed a method of performing exposure using exposure light having different wavelengths by providing a filter, on an optical path between a light source and a wafer, which selectively transmit light beams in a plurality of wavelength bands.

Japanese Patent Laid-Open No. 6-252021 has proposed a method of performing exposure using exposure light obtained by cumulatively synthesizing a plurality of wavelengths by changing the set wavelength of a light source in a wafer exposure step.

In a currently available exposure apparatus, it is necessary to stabilize the optical quality of a light source at the time of exposure or calibration for the exposure apparatus.

FIG. 1 shows the spectrum shape of light (single-wavelength light) emitted from a light source. The abscissa represents a wavelength λ of light; and ordinate, the intensity of the light at the wavelength.

As shown in FIG. 1, a currently available exposure apparatus uses a central wavelength λ0, FWHM (Full Width Half Maximum), and E95 as evaluation indexes for optical quality. FWHM means the spectrum width measured at an intensity ½ the peak light intensity of the profile of a spectrum. E95 means the spectrum width at which 95% energy in a spectrum concentrates.

The exposure apparatus monitors λ0, FWHM, and E95 immediately before or during exposure, and calculates a variation 3σ in each measured value, and an error value (error relative to a command value), thereby checking the stability of optical quality.

In exposure using exposure light including a plurality of wavelengths, it is necessary to stabilize optical quality at the time of exposure or calibration for the exposure apparatus.

However, light including a plurality of wavelengths has a spectrum like that shown in FIG. 2. Even if, therefore, λ0, FWHM, and E95 as conventional indexes are obtained for the entire spectrum of light including a plurality of wavelengths, it is impossible to satisfactorily check optical quality based on these indexes.

When, for example, a reticle pattern is projected on a wafer by using light including two peaks as shown in FIG. 2, adverse effects like image blurring occur. It is therefore necessary to control/monitor a difference Ediff between peak light intensities during exposure.

### SUMMARY OF THE INVENTION

The present invention has been made in consideration of the above background, and provides a novel technique of determining, based on the spectrum of light, whether an object should be exposed to light.

An exposure apparatus according to a first aspect of the present invention, exposes a substrate to light, and the apparatus comprises: a light source configured to generate a first pulsed light having a single peak at a first wavelength, and a second pulsed light having a single peak at a second wavelength; a measuring device configured to measure a spectrum of the first pulsed light and a spectrum of the second pulsed light, respectively; a processor configured to calculate a central wavelength of accumulated light to be obtained by accumulating the first pulsed light and the second pulsed light, based on spectra measured by the measuring device; and a controller, wherein the processor is configured to obtain a synthetic spectrum by synthesizing the spectrum of the first pulsed light and the spectrum of the second pulsed light, to obtain a central wavelength and light intensity of each of a plurality of spectrum elements included in the synthetic spectrum, and to calculate the central wavelength of the accumulated light based on the obtained central wavelength and light intensity of each of the plurality of spectrum elements, and the controller is configured to determine, based on the calculated central wavelength of the accumulated light, whether the substrate should be exposed to light.

An exposure apparatus according to a second aspect of the present invention, exposes a substrate to light, and the apparatus comprises: a light source configured to generate a first pulsed light having a single peak at a first wavelength, and a second pulsed light having a single peak at a second wavelength; a measuring device configured to measure a spectrum of the first pulsed light and a spectrum of the second pulsed light, respectively; a processor configured to calculate a central wavelength of accumulated light to be obtained by accumulating the first pulsed light and the second pulsed light based on spectra measured by the measuring device; and a controller, wherein the processor is configured to obtain a synthetic spectrum by synthesizing a spectrum of the first pulsed light and a spectrum of the second pulsed light, to accumulate a plurality of spectrum elements included in the synthetic spectrum in the order of peak wavelengths thereof, and to calculate, as the central wavelength of the accumulated light, a wavelength at which the accumulated value becomes half of the maximum accumulated value, and the controller determines, based on the calculated central wavelength of the accumulated light, whether the substrate should be exposed to light.

A method of manufacturing a device according to a third and fourth aspect of the present invention comprises: exposing a substrate to light using an exposure apparatus according to the respective first and second aspect of the present invention; developing the exposed substrate, and processing the developed substrate to manufacture the device.

According to the present invention, there is provided a novel technique of determining, based on the spectrum of light, whether an object should be exposed to light.

Further features of the present invention will become apparent from the following description of exemplary embodiments with reference to the attached drawings.

### BRIEF DESCRIPTION OF THE DRAWINGS

FIG. 1 is a graph showing an example of the spectrum of light having a single wavelength;

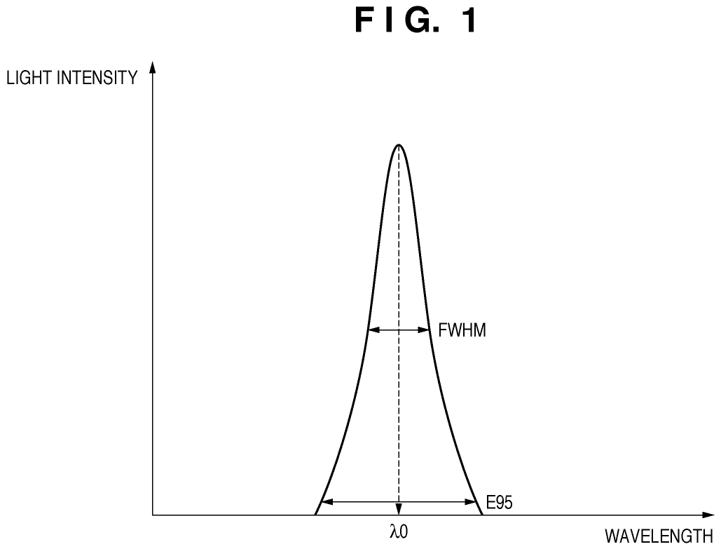

FIG. 2 is a graph showing an example of the spectrum of light having a plurality of wavelengths;

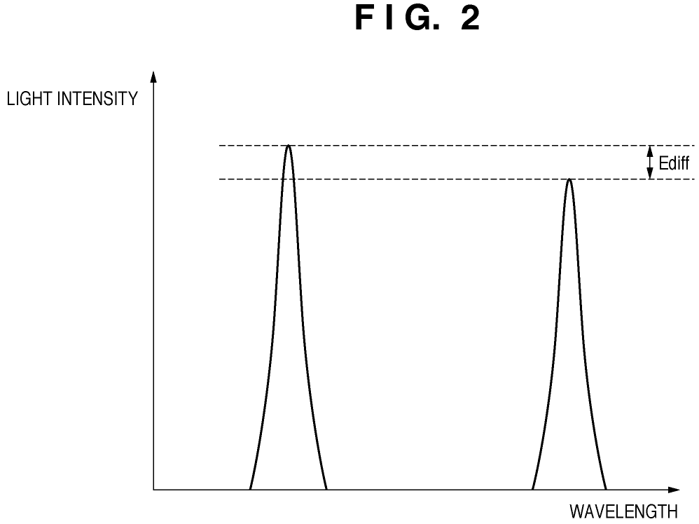

FIG. 3 is a graph for explaining the optical quality parameters of light having a plurality of wavelengths;

FIG. 4 is a block diagram showing the schematic arrangement of an exposure apparatus according to a preferred embodiment of the present invention;

FIG. 5 is a flowchart showing an optical quality lock sequence and an oscillation sequence;

FIG. 6 is a graph showing an example of the definition of the central wavelength of light having a plurality of wavelengths; and

FIG. 7 is a graph showing an example of the definition of the central wavelength of light having a plurality of wavelengths.

### DESCRIPTION OF THE EMBODIMENTS

A preferred embodiment of the present invention will be described below with reference to the accompanying drawings.

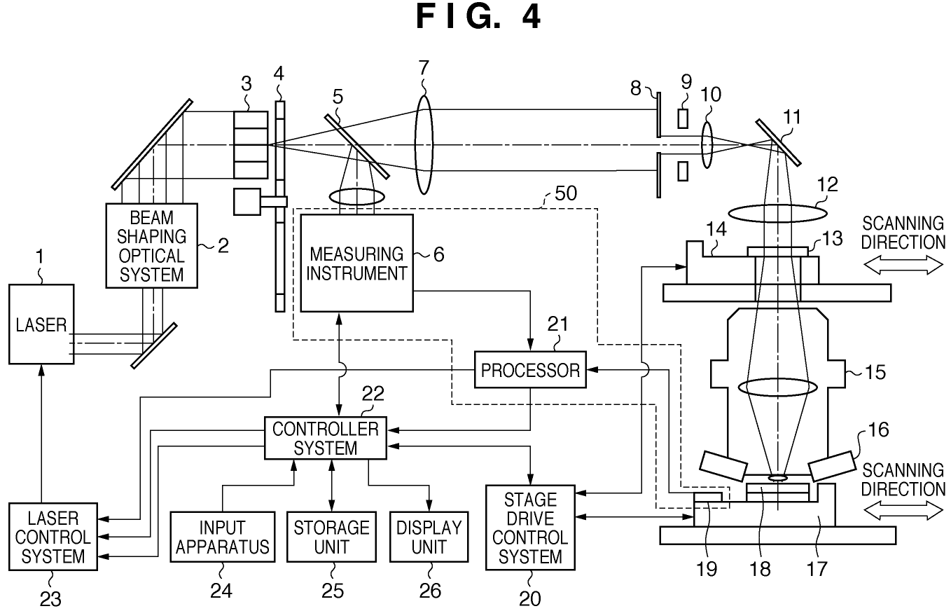

FIG. 4 is a view showing the schematic arrangement of an exposure apparatus according to a preferred embodiment of the present invention. The exposure apparatus is configured as a scanning exposure apparatus in this embodiment.

Referring to FIG. 4, a light source (laser) 1 emits a first pulse light beam having a single peak at a first wavelength and a second pulse light beam having a peak at a second wavelength.

That is, the light source 1 can emit a plurality of pulse light beams for exposure (multiple exposure) while changing a wavelength a plurality of number of times or continuously. In this case, if a plurality of pulse light beams has different peak wavelengths, the focus position of the projection lens of a projection optical system 15 fluctuates due to chromatic aberration.

For example, a KrF excimer laser generally oscillates at a central wavelength (peak wavelength) of 248.3 nm with half-value width of 350 pm to emit a pulse light beam. When this KrF excimer laser emits a plurality of pulse light beams, the half-value width of each pulse light beam can be narrowed to 3 pm by using a diffraction grating, etalon, prism, or the like so as to suppress chromatic aberration due to the plurality of pulse light beams. For example, slightly rotating a band narrowing element makes it possible to generate a plurality of pulse light beams having undergone narrowing of the band by oscillating the KrF excimer laser at central wavelengths (peak wavelengths) of 248.2 nm and 248.31 nm.

The light emitted from the light source (laser) 1 passes through a beam shaping optical system 2 to be shaped into a predetermined shape. The light then strikes the plane of incidence of an optical integrator 3. The optical integrator 3 comprises a plurality of microlenses, and forms many secondary light sources near the plane of exit.

A stop turret 4 is placed on the plane-of-exit side of the optical integrator 3. The stops buried in the stop turret 4 limit the size of the secondary light source plane formed by the optical integrator 3. A plurality of stops assigned with illumination mode numbers is buried in the stop turret 4. When the shape of the incident light source of illumination light is to be changed, a necessary stop is selected and inserted into the optical path. Such stops can include, for example, aperture stops having different circular aperture areas for setting a plurality of different coherent factors, that is, σ values, ring-shaped stops for annular illumination, and quadrupole stops.

A condenser lens 7 performs Koehler illumination on a blind 8 with a light beam from a secondary light source near the plane of exit of the optical integrator 3. A slit member 9 is placed near the blind 8 to form the profile of slit light illuminating the blind 8 into a rectangular or arcuated shape. The slit light forms an image on a reticle 13, which is placed on the conjugate plane of the blind 8 and on which an element pattern is formed, via a condenser lens 10 , a mirror 11 and a condenser lens 12, with uniform illuminance and incident angle. The opening region of the blind 8 is similar in shape to the pattern exposure area of the reticle (mask) 13 at an optical magnification ratio. At the time of exposure, the blind 8 shields the reticle 13 other than the exposure area and at the same time light is used to perform synchronous scanning on a reticle stage 14 at an optical magnification.

The reticle stage (mask stage) 14 holds the reticle 13. Slit light passing through the reticle 13 passes through the projection optical system 15 and forms an image again as slit light in an exposure angle-of-view area on a plane (image plane) optically conjugate with the pattern surface of the reticle 13. A focus detection system 16 detects the height and inclination of an exposure surface on a wafer 18 held by a wafer stage (substrate stage) 17. In scanning exposure, while the reticle stage 14 and the wafer stage 17 synchronously travel, the wafer (substrate) 18 is exposed to the slit light, thereby forming a latent image on the photoresist on the wafer 18. At this time, the wafer stage 17 drives the wafer so as to match the exposure surface of the wafer 18 with the image plane on the basis of the information provided from the focus detection system 16.

A stage drive control system 20 controls the reticle stage 14 and the wafer stage 17. At the time of scanning exposure, the stage drive control system 20 causes the reticle stage 14 and the wafer stage 17 to synchronously travel, while controlling the position of the exposure surface (wafer surface).

A measurement unit 50 measures the spectra of first and second pulse light beams generated from the light source 1, and calculates the central wavelength of the light obtained by accumulating the first and second pulse light beams. The measurement unit 50 includes a first measuring instrument 6, a second measuring instrument 19, and a processor 21.

The first measuring instrument 6 measures the spectrum of light reflected by a half mirror 5 and extracted from the optical path. The first measuring instrument 6 measures the spectra of the first and second pulse light beams. The first measuring instrument 6 provides the spectra of the first and second pulse light beams to the processor 21.

The second measuring instrument 19 is placed on the wafer stage 17. The second measuring instrument 19 measures the spectrum of slit light within an exposure angle of view. The second measuring instrument 19 measures the spectra of the first and second pulse light beams. The second measuring instrument 19 provides the spectra of the first and second pulse light beams to the processor 21.

Based on the spectra measured by the first and second measuring instruments 6 and 19, the processor 21 calculates the amount and central wavelength of the light obtained by accumulating the first and second pulse light beams. The first measuring instrument 6 measures the spectra of the first and second pulse light beams during exposure of the wafer. Before an exposure step, the second measuring instrument 19 measures the spectra of the first and second pulse light beams applied to the wafer 18. The processor 21 synthesizes the spectra of a plurality of pulse light beams received from the first measuring instrument 6, and obtains the spectrum of the light obtained by accumulating the plurality of pulse light beams as the synthetic spectrum of the light measured by the first measuring instrument 6. The processor 21 synthesizes the spectra of a plurality of pulse light beams received from the second measuring instrument 19, and obtains the spectrum of the light obtained by synthesizing the plurality of pulse light beams as the synthetic spectrum of the light measured by the second measuring instrument 19. Before an exposure step, the processor 21 obtains the correlation between the amount of light obtained from the synthetic spectrum of the light measured by the first measuring instrument 6 and the amount of light obtained from the synthetic spectrum of the light measured by the second measuring instrument 19. During exposure of the wafer, using this correlation, the processor 21 converts the amount of light obtained from the synthetic spectrum of the light measured by the first measuring instrument 6 into an amount of light on the wafer 18, and provides it as a monitored amount of light for exposure light amount control to a controller system 22.

The processor 21 obtains a plurality of spectrum elements (first and second spectrum elements) included in the synthetic spectrum, and obtains the central wavelengths and light intensities of the respective spectrum elements. The processor 21 calculates the central wavelength of the light obtained by accumulating the plurality of pulse light beams based on the obtained central wavelengths and light intensities of the plurality of spectrum elements. The processor 21 provides the information of the central wavelength of the light to the controller system 22.

A laser control system 23 controls the oscillation frequency and output energy of the light source 1 by outputting a trigger signal and an applied voltage signal in accordance with a target pulse light amount. The laser control system 23 generates a trigger signal and an applied voltage signal based on a pulse light amount signal from the processor 21 and exposure parameters from the controller system 22.

Exposure parameters (e.g., an integrated exposure light amount, a necessary integrated exposure light amount accuracy, and a stop shape) are input to the controller system 22 with an input apparatus 24 as a man-machine interface or media interface and stored in a storage unit 25. A display unit 26 can display the light amount correlation or the like obtained from the synthetic spectra of light beams which are measured by the first measuring instrument 6 and the second measuring instrument 19.

The controller system (controller) 22 calculates a parameter group necessary for scanning exposure based on the data supplied from the input apparatus 24, parameters unique to the exposure apparatus, and the data provided from measuring instruments such as the first measuring instrument 6 and the second measuring instrument 19. The calculated parameter group is provided to the laser control system 23 and the stage drive control system 20. The controller system 22 determines, on the basis of the central wavelength of the light (the central wavelength of the accumulated light) calculated by the processor 21, whether the substrate should be exposed to light.

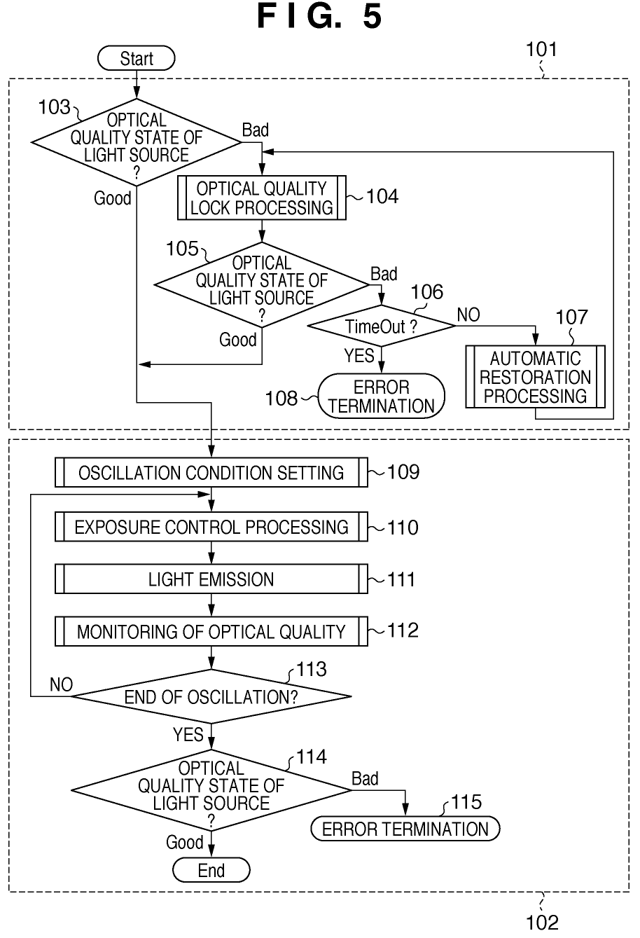

FIG. 5 is a flowchart schematically showing an optical quality lock sequence and an oscillation sequence which are controlled by the controller system 22. When a reticle pattern is to be transferred onto a wafer by exposure or the exposure apparatus is calibrated in association with the light source 1, the exposure apparatus repeatedly executes an optical quality lock sequence 101 and an oscillation sequence 102.

In the optical quality lock sequence 101, if it is determined that the quality of the light obtained by synthesizing pulse light beams generated by the light source 1 (to be referred to as the optical quality of the light source hereinafter) is in a BAD state (a state in which the optical quality performance cannot be guaranteed), oscillation processing is executed to improve the optical quality to the required accuracy. The oscillation sequence 102 is a sequence for exposing a wafer to light or calibrating the exposure apparatus.

If it is determined in step 103, upon checking the optical quality state of the light source, that the optical quality is GOOD (a state in which the optical quality can be guaranteed), the process shifts to the oscillation sequence 102. If the optical quality is BAD (a state in which the optical quality performance cannot be guaranteed), the process shifts to step 104.

Step 104 is an optical quality lock processing. In this step, the optical quality state is stabilized by executing idle oscillation which does not contribute to wafer exposure or apparatus calibration.

If it is determined in step 105, upon checking the optical quality state of the light source, that the optical quality is GOOD (a state in which the optical quality performance can be guaranteed), the process shifts to the oscillation sequence 102. If the optical quality is BAD (a state in which the optical quality performance cannot be guaranteed), the process shifts to step 106.

It is determined in step 106 whether the number of times of execution of the optical quality lock sequence 101 exceeds a specified number of times. If YES in step 106, the process shifts to step 108. If the number of times of execution of the optical quality lock sequence 101 is less than the specified number of times, the optical quality lock sequence 101 is executed again after automatic restoration processing 107.

Step 107 is an automatic restoration processing. In this step, the deteriorating optical quality is improved by re-adjusting the chamber gas mixing ratio of the light source 1, the chamber gas pressure, and the spectral element (grating) in accordance with the optical quality state of the light source 1. If, for example, the width (FWHM or E95) of each spectrum element of light generated by the light source 1 falls outside the specification, it is effective to adjust the spectrum width to a desired one by adjusting the F2 gas concentration in the chamber of the light source 1 and the gas pressure in the chamber of the light source 1.

Alternatively, if the central wavelength (λ0, (λ0—center), or the like) of the light source shifts from the set value, it is effective to correct the shift amount of the wavelength by adjusting the spectral element (grating).

Step 108 is an error termination step. This step is executed if the optical quality cannot be improved after a specified number of times of execution of the automatic restoration processing 107. In this case, hardware repair (e.g., replacing the chamber of the light source) is required for the restoration of optical quality. In this processing, therefore, the operator is notified of the need of hardware repair, and the exposure apparatus is stopped (the subsequent processing is not executed).

Step 109 is an oscillation condition setting sequence. In this step, settings are made for the stage drive control system 20 and the laser control system 23 by calculating the scan speed of the stage, the oscillation frequency of the light source, target energy, the number of pulse light beams to be emitted, and the like in accordance with a set amount of exposure light and the like.

Step 110 is an exposure control processing sequence. In this step, the output power of light generated by the light source 1 is detected based on the spectrum measured by the first measuring instrument 6, and computation processing for target energy necessary for the next pulse light beam to be emitted is executed.

In step 111, the computed target energy command value is set in the light source 1 to emit light.

In step 112, the optical quality of the light source is monitored for each emitted pulse light beam.

In step 113, it is checked whether a termination condition for oscillation (e.g., the number of pulse light beams emitted or the accumulated value of energy obtained by oscillation) is satisfied. If the condition is satisfied, the process shifts to step 114. If the condition is not satisfied, the process returns to step 110 to continue the oscillation processing.

In step 114, if it is determined, upon checking the optical quality state of the light source, that the optical quality is GOOD (a state in which the optical quality performance can be guaranteed), the processing is normally terminated. If the optical quality is BAD (a state in which the optical quality performance cannot be guaranteed), the process shifts to step 115.

In this case, the sequence can be changed so as to execute decision step 114 between steps 112 and 113. That is, decision step 114 can be executed for each emitted pulse light beam or after oscillation. Step 115 is an error termination step.

The method of evaluating the optical quality of the light source in the preferred embodiment of the present invention is suitable for steps 103, 105, and 114 in FIG. 5.

Methods of evaluating the optical quality of light emitted from the light source 1 (the light obtained by accumulating the first and second pulse light beams generated by the light source 1) based on the spectrum (synthetic spectrum) of the light will be exemplarily described below.

(First Evaluation Method)

The first evaluation method evaluates the quality of light obtained by synthesizing a plurality of pulse light beams generated by the light source 1 based on the central wavelength of the light. The central wavelength of light can be defined as a parameter calculated in consideration of the barycenter of the light intensities of a plurality of spectrum elements included in the synthetic spectrum of a plurality of pulse light beams generated by the light source 1.

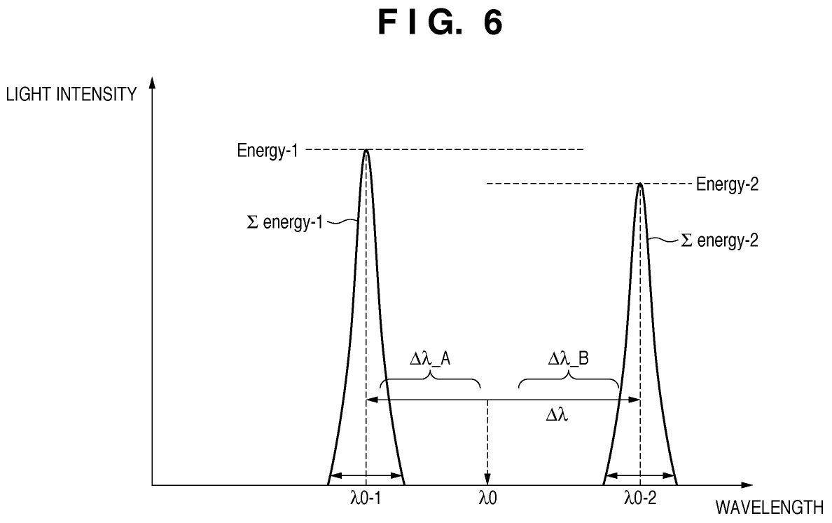

This method will be described with reference to an example of two spectrum elements shown in FIG. 6. With regards to the spectrum element on the short-wavelength side, let (λ0−1) be the central wavelength, (Energy−1) be the peak light intensity, and (Σenergy−1) be the sum total of energy. With regards to the spectrum element on the long-wavelength side, let (π0−2) be the central wavelength, (Energy−2) be the peak light intensity, and (Σenergy−2) be the sum total of energy.

Δλ is represented by the difference ((λ0−2)−(λ0−1)) between the central wavelengths of the two spectrum elements, and Δλ_A and Δλ_B are determined by the ratio between the peak light intensities of the two spectrum elements or the ratio between the sum totals of energy of the two spectrum elements, as indicated by equation (3).

$$Δλ\_A \text{:} Δλ\_B = ( Energy - 2 ) \text{:} ( Energy - 1 ) ( or ( \sum energy - 2 ) \text{:} ( \sum energy - 1 ) ) \qquad ( 3 )$$

In this case, the central wavelength λ0 of light generated by the light source 1 can be defined by equation (4).

λ0=(λ0−1)+Δλ*(Δλ_{—}A/(Δλ_{—}A+Δλ_{—}B)) (4)

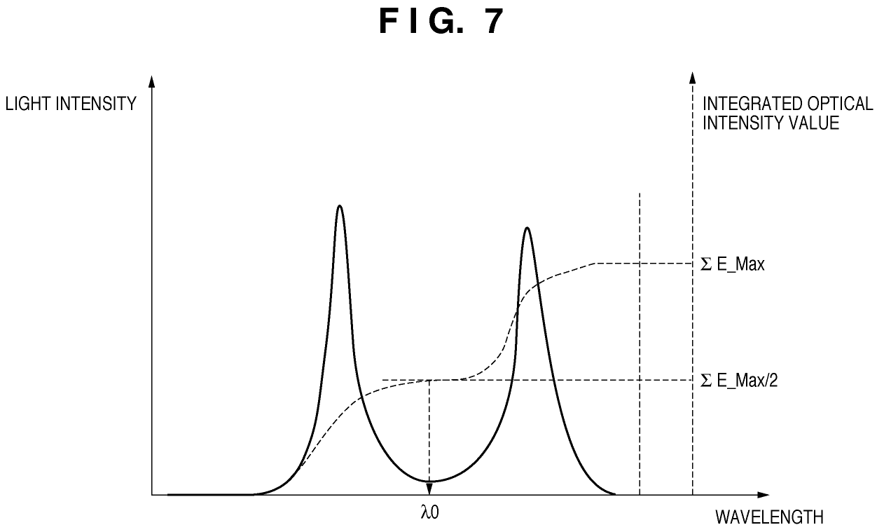

Alternatively, as shown in FIG. 7, it suffices to integrate the light intensity of the spectrum element on the short-wavelength side (or the long-wavelength side) of a synthetic spectrum including the two spectrum elements and define, as the central wavelength λ0, the wavelength at which the integrated light intensity value becomes ½ the maximum value.

The processor 21 obtains a synthetic spectrum by synthesizing the spectra of a plurality of pulse light beams provided from at least one of the first measuring instrument 6 and the second measuring instrument 19. The processor 21 obtains the central wavelength and light intensity of each of the plurality of spectrum elements included in the synthetic spectrum. The processor 21 then calculates the central wavelength λ0 of the accumulated light based on the obtained central wavelength and light intensity of each of the plurality of spectrum elements, and provides the central wavelength λ0 to the controller system 22.

The controller system (controller) 22 can check the optical quality state of the light source based on, for example, at least one of λ0, a variation (e.g., 3σ) in λ0 of the plurality of spectrum elements, and an error value (an error in λ0 relative to a command value).

A threshold for the determination of the parameter λ0 can be stored in the storage unit 25 of the exposure apparatus in advance. The controller system (controller) 22 compares a parameter (λ0, a variation in λ0, or an error relative to a command value) with the determination threshold in decision steps 103, 105, and 113. If the monitoring result on the optical quality does not satisfy the required accuracy recorded in the exposure apparatus, error termination (steps 108 and 115 in FIG. 5), automatic restoration processing (step 107 in FIG. 5), or an optical quality lock sequence (step 104 in FIG. 5) is executed.

(Second Evaluation Method)

The second evaluation method evaluates the optical quality based on the correlation between the peak light intensities of the plurality of spectrum elements included in the synthetic spectrum of the light generated by the light source 1.

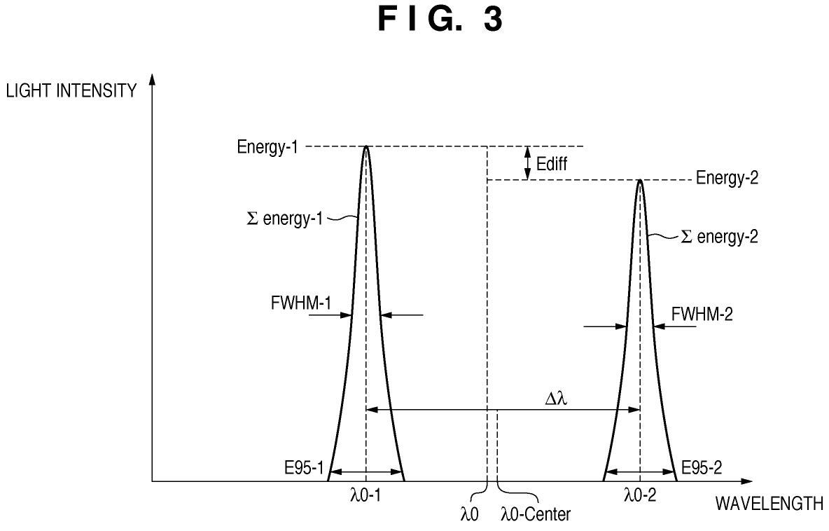

As exemplified by FIG. 3, with regard to the spectrum of the light obtained by synthesizing two pulse light beams, the peak light intensity (maximum value) of the spectrum element on the short-wavelength side is represented by (Energy−1), and the peak light intensity (maximum value) of the spectrum element on the long-wavelength side is represented by (Energy−2).

The processor 21 calculates the difference Ediff between the peak light intensities (or light amounts or energies) of a plurality of spectrum elements in the synthetic spectrum of a plurality of pulse light beams provided from at least one of the first measuring instrument 6 and the second measuring instrument 19, and provides the difference Ediff to the controller system 22. The difference Ediff is given by

Ediff=|(Energy−1)−(Energy−2)| (5)

The processor 21 can calculate a ratio RE between the peak light intensities of the two spectrum elements in the synthetic spectrum of a plurality of pulse light beams provided from at least one of the first measuring instrument 6 and the second measuring instrument 19, and provide the radio RE to the controller system 22. The ratio RE is given by

RE=(Energy−1)/(Energy−2) (6)

The controller system 22 can check the optical quality state of the light source based on, for example, at least one of Ediff, a variation (e.g., 3σ) in Ediff among a plurality of spectrum elements, and an error value (an error in Ediff relative to a command value). Alternatively, the controller system 22 checks the optical quality state of the light source based on, for example, at least one of ER, a variation (e.g., 3σ) in ER among a plurality of spectrum elements, and an error value (an error in ER relative to a command value).

In this case, the processor 21 can calculate both Ediff and ER, and the controller system 22 can check the optical quality state of the light source based on both Ediff and ER.

Thresholds for the determination of the parameters Ediff and ER can be recorded in the storage unit 25 of the exposure apparatus in advance. The controller system (controller) 22 compares the parameters with the thresholds in determination steps 103, 105, and 113. If the monitoring result on the optical quality does not satisfy the required accuracy recorded in the exposure apparatus, error termination (steps 108 and 115 in FIG. 5), automatic restoration processing (step 107 in FIG. 5), or an optical quality lock processing (step 104 in FIG. 5) is executed.

(Third Evaluation Method)

The third evaluation method evaluates the quality of light generated by the light source 1 based on the difference between the central wavelengths of a plurality of spectrum elements included in the synthetic spectrum of the light or the average of the central wavelengths.

This method will be described with reference to an example of two spectrum elements shown in FIG. 3. In the example shown in FIG. 3, let (λ0−1) be the central wavelength of the spectrum element on the short-wavelength side, and (λ0−2) be the central wavelength of the spectrum element on the long-wavelength side.

In this case, the central wavelength of each spectrum element can be defined as the wavelength at which each spectrum element exhibits the maximum light intensity. Alternatively, the central wavelength of each spectrum element can be defined as the wavelength at which the accumulated value obtained by sequentially accumulating the light intensities of the respective spectrum elements from the short-wavelength side to the long-wavelength side becomes half of the maximum value (maximum accumulated value) of the integrated light intensity value.

The processor 21 calculates the difference Δλ (=|(λ0−2)−(λ0−1)|) between the central wavelengths of a plurality of spectrum elements in the synthetic spectrum of a plurality of pulse light beams provided from at least one of the first measuring instrument 6 and the second measuring instrument 19, and provides the difference Δλ to the controller system 22. The processor 21 can calculate a center position (λ0−center) (=(λ0−1)+(Δλ/2)) between the two central wavelengths of a plurality of spectrum elements in the synthetic spectrum of the plurality of pulse light beams, and provide the center position to the controller system 22.

The controller system 22 can check the optical quality state of the light source based on, for example, at least one of Δλ, a variation (e.g., 3σ) in Δλ among the plurality of spectrum elements, and an error value (an error in Δλ relative to a command value). Alternatively, the controller system 22 can check the optical quality state of the light source based on, for example, at least one of (λ0−center), a variation (e.g., 3σ) in (λ0−center) among the plurality of spectrum elements, and an error value (an error relative to a command value).

The processor 21 can calculate both Δλ and (λ0−center), and the controller system 22 can check the optical quality state of the light source based on both Δλ and (λ0−center).

Thresholds for the determination of the parameters Δλ and (λ0−center) can be recorded in the storage unit 25 of the exposure apparatus in advance. The controller system (controller) 22 compares the parameters with the thresholds in decision steps 103, 105, and 113. If the monitoring result on the optical quality does not satisfy the required accuracy recorded in the exposure apparatus, error termination (steps 108 and 115 in FIG. 5), automatic restoration processing (step 107 in FIG. 5), or an optical quality lock processing (step 104 in FIG. 5) is executed.

(Fourth Evaluation Method)

The fourth evaluation method evaluates the quality of light generated by the light source 1 based on the FWHM of each of a plurality of spectrum elements included in the synthetic spectrum of the light. In this case, the FWHM of each spectrum element is defined as the width (spectrum width) of the pulse light beam at an intensity ½ the peak light intensity of each spectrum element.

With regard to the two spectrum elements exemplified by FIG. 3, the FWHM of the spectrum element on the short-wavelength side corresponds to FWHM-1, and the FWHM of the spectrum element on the long-wavelength side corresponds to FWHM-2.

The processor 21 calculates the FWHMs of a plurality of spectrum elements in the synthetic spectrum of a plurality of pulse light beams provided from at least one of the first measuring instrument 6 and the second measuring instrument 19, and provides the FWHMs to the controller system 22.

The controller system 22 can check the optical quality state of the light source, for each spectrum element, on the basis of at least one of FWHM, a variation (3σ) in FWHM among the plurality of spectrum elements, and an error value (an error in FWHM relative to a command value).

A threshold for the determination of the parameter FWHM can be recorded in the storage unit 25 of the exposure apparatus in advance. The controller system (controller) 22 compares the parameter with the threshold in determination steps 103, 105, and 113. If the monitoring result on the optical quality does not satisfy the required accuracy recorded in the exposure apparatus, error termination (steps 108 and 115 in FIG. 5), automatic restoration processing (step 107 in FIG. 5), or an optical quality lock processing (step 104 in FIG. 5) is executed.

(Fifth Evaluation Method)

The fifth evaluation method evaluates the quality of light generated by the light source 1 based on E95 of each of a plurality of spectrum elements included in the synthetic spectrum of the light. E95 of each spectrum element is defined as a spectrum width, of the profile of the spectrum element, within which 95% energy concentrates.

With regard to the two spectrum elements exemplified by FIG. 3, E95 of the spectrum element on the short-wavelength side corresponds to E95-1, and E95 of the spectrum element on the long-wavelength side corresponds to E95-2.

The processor 21 calculates E95 of each of a plurality of spectrum elements in the synthetic spectrum of a plurality of pulse light beams provided from at least one of the first measuring instrument 6 and the second measuring instrument 19, and provides E95 to the controller system 22.

The controller system 22 can check the optical quality state of the light source, for each spectrum element, based on at least one of E95, a variation (3σ) in E95 among the plurality of spectrum elements, and an error value (an error in E95 relative to a command value).

A threshold for the determination of the parameter E95 can be recorded in the storage unit 25 of the exposure apparatus in advance. The controller system (controller) 22 compares the parameter with the threshold in determination steps 103, 105, and 113. If the monitoring result on the optical quality does not satisfy the required accuracy recorded in the exposure apparatus, error termination (steps 108 and 115 in FIG. 5), automatic restoration processing (step 107 in FIG. 5), or an optical quality lock processing (step 104 in FIG. 5) is executed.

(Sixth Evaluation Method)

The sixth evaluation method evaluates the quality of light generated by the light source 1 based on the sum total of energy of each of a plurality of spectrum elements included in the synthetic spectrum of the light. In this case, the sum total of energy of a spectrum element is the value obtained by integrating the light intensity of the profile of the spectrum element.

With regard to the two spectrum elements exemplified by FIG. 3, the sum total Σenergy of energy of the spectrum element on the short-wavelength side corresponds to (Σenergy−1), and the sum total of energy of the spectrum element on the long-wavelength side corresponds to (Σenergy−2).

The processor 21 calculates Σenergy of each of a plurality of spectrum elements in the synthetic spectrum of a plurality of pulse light beams provided from at least one of the first measuring instrument 6 and the second measuring instrument 19, and provides Σenergy to the controller system 22.

The controller system 22 evaluates, for each spectrum element, at least one of Σenergy, a variation (3σ) in Σenergy of the plurality of spectrum elements, and an error value (an error in Σenergy relative to a command value). This makes it possible to check the optical quality state of the light source.

A threshold for the determination of the parameter Σenergy can be recorded in the storage unit 25 of the exposure apparatus in advance. The controller system (controller) 22 compares the parameter with the threshold in determination steps 103, 105, and 113. If the monitoring result on the optical quality does not satisfy the required accuracy recorded in the exposure apparatus, error termination (steps 108 and 115 in FIG. 5), automatic restoration processing (step 107 in FIG. 5), or an optical quality lock processing (step 104 in FIG. 5) is executed.

Note that it suffices to execute moving average processing with a Window size matching an actual exposure condition and compute a variation (3σ) and an error value (an error component relative to a command value) from the execution result.

The Window size at the time of scanning exposure is obtained from an oscillation frequency F of the light source and a scanning velocity V of the stage (see equation 7), and indicates the number of pulses of exposure light to be applied per point on a wafer.

Window size=F/V [pulse/mm] (7)

The optical quality of the light source can be checked by using at least two of the first to sixth evaluation methods.

According to the preferred embodiment of the present invention, even if light obtained by synthesizing a plurality of pulse light beams is to be used, it is possible to execute exposure or calibration upon checking optical quality necessary for substrate exposure or apparatus calibration.

In addition, even if the optical quality deteriorates during substrate exposure or apparatus calibration, since the failure of exposure/calibration can be immediately detected, automatic restoration processing can be quickly executed. The downtime of the exposure apparatus can therefore be minimized.

A method of manufacturing a device according to the preferred embodiment of the present invention is suitable for the manufacture of devices (e.g., a semiconductor device and liquid crystal device). This method can include a step of exposing a substrate coated with a photoresist to light by using the above exposure apparatus, and a step of developing the substrate exposed in the exposing step. In addition to the above steps, a device is manufactured through other known steps (e.g., film forming, evaporation, doping, planarization, etching, resist removing, dicing, bonding, and packaging steps).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-244442, filed Sep. 20, 2007, which is hereby incorporated by reference herein in its entirety.

What is claimed is:

1. An exposure apparatus for exposing a substrate to light, the apparatus comprising:
a light source configured to generate a first pulsed light having a single peak at a first wavelength, and a second pulsed light having a single peak at a second wavelength;
a measuring device configured to measure a spectrum of the first pulsed light and a spectrum of the second pulsed light, respectively;
a processor configured to calculate a central wavelength of accumulated light to be obtained by accumulating the first pulsed light and the second pulsed light, based on spectra measured by the measuring device; and
a controller, wherein
the processor is configured to obtain a synthetic spectrum by synthesizing the spectrum of the first pulsed light and the spectrum of the second pulsed light, to obtain a central wavelength and light intensity of each of a plurality of spectrum elements included in the synthetic spectrum, and to calculate the central wavelength of the accumulated light based on the obtained central wavelength and light intensity of each of the plurality of spectrum elements, and
the controller is configured to determine, based on the calculated central wavelength of the accumulated light, whether the substrate should be exposed to light.

2. An apparatus according to claim 1, wherein
the synthetic spectrum includes a first spectrum element and a second spectrum element, and
letting (λ0−1) be a central wavelength of the first spectrum element, (λ0−2) ((λ0−2)>(λ0−1)) be a central wavelength of the second spectrum element, (Energy−1) be a peak light intensity of the first spectrum element, (Energy−2) be a peak light intensity of the second spectrum element, Δλ be equal to (λ0−2)−(λ0−1), and λ0 be the central wavelength of the accumulated light, the processor is configured to calculate λ0 according to following equations:
λ0=(λ0−1)+Δλ*(Δλ_{—}A/(Δλ_{—}A+Δλ_{—}B))
Δλ_{—}A: Δλ_{—}B=(Energy−2): (Energy−1).

3. An apparatus according to claim 1, wherein
the synthetic spectrum includes a first spectrum element and a second spectrum element, and
letting (λ0−1) be a central wavelength of the first spectrum element, (λ0−2) ((λ0−2)>(λ0−1)) be a central wavelength of the second spectrum element, (Σenergy−1) be a sum total of light intensity of the first spectrum element, (Σenergy−2) be a sum total of light intensity of the second spectrum element, Δλ be equal to (λ0−2)−(λ0−1), and λ0 be a central wavelength of the accumulated light, the processor is configured to calculate λ0 according to following equations:
λ0=(λ0−1)+Δλ*(Δλ_{—}A/(Δλ_{—}A+ΔλB))
Δλ_A: Δλ_{—}B=(Σenergy−2): (Σenergy−1).

4. An exposure apparatus for exposing a substrate to light, the apparatus comprising:
a light source configured to generate a first pulsed light having a single peak at a first wavelength, and a second pulsed light having a single peak at a second wavelength;
a measuring device configured to measure a spectrum of the first pulsed light and a spectrum of the second pulsed light, respectively;
a processor configured to calculate a central wavelength of accumulated light to be obtained by accumulating the first pulsed light and the second pulsed light based on spectra measured by the measuring device; and
a controller, wherein
the processor is configured to obtain a synthetic spectrum by synthesizing a spectrum of the first pulsed light and a spectrum of the second pulsed light, to accumulate a plurality of spectrum elements included in the synthetic spectrum in the order of peak wavelengths thereof, and to calculate, as the central wavelength of the accumulated light, a wavelength at which the accumulated value becomes half of the maximum accumulated value, and
the controller determines, based on the calculated central wavelength of the accumulated light, whether the substrate should be exposed to light.

5. An apparatus according to claim 1, wherein
the controller is configured to control a state of the light source based on the calculated central wavelength of the accumulated light.

6. An apparatus according to claim 4, wherein
the controller is configured to control a state of the light source based on the calculated central wavelength of the accumulated light.

7. A method of manufacturing a device, the method comprising:
exposing a substrate to light using an exposure apparatus defined in claim 1;
developing the exposed substrate; and
processing the developed substrate to manufacture the device.

8. A method of manufacturing a device, the method comprising:
exposing a substrate to light using an exposure apparatus defined in claim 4;
developing the exposed substrate; and
processing the developed substrate to manufacture the device.
